(19) United States
(12) Patent Application Publication
(10) Pub. No.: US 2026/0229225 A1
(43) Pub. Date: Aug. 6, 2026

(54) SPEECH RECOGNITION MODEL TRAINING DEVICE, SPEECH RECOGNITION MODEL TRAINING METHOD, AND SPEECH RECOGNITION MODEL TRAINING PROGRAM

(71) Applicant: NEC Corporation, Tokyo (JP)

(72) Inventors: Tasuku KITADE, Tokyo (JP); Masanori TSUJIKAWA, Tokyo (JP); Yutaka UNO, Tokyo (JP); Kei SHIBUYA, Tokyo (JP); Kenji Araki, Tokyo (JP)

(73) Assignee: NEC Corporation, Tokyo (JP)

(21) Appl. No.: 19/152,595

(22) PCT Filed: Feb. 14, 2023
(86) PCT No.: PCT/JP2023/005006

§ 371 Date: Jul. 31, 2025

(51) Int. Cl. G10L 15/06; G10L 13/027

(52) U.S. Cl. CPC G10L 15/063; G10L 13/027

(57) ABSTRACT

A speech recognition model training device includes: a memory configured to store instructions; and one or more processors configured to execute the instructions to: perform machine learning using text data of a target domain and synthesized speech data related to the text data of the target domain and generate a pre-trained model; and perform machine learning on the pre-trained model using text data of a second domain different from the target domain and natural voice data related to the text data of the second domain and generate a speech recognition model of the target domain. The device can support automated decision making using the speech recognition model.

### TECHNICAL FIELD

The present invention relates to a speech recognition model training device, a speech recognition model training method, and a speech recognition model training program.

### BACKGROUND ART

In recent years, a technique for creating a speech recognition model by machine learning has been developed (for example, PTL 1).

At this time, in a case where there is a small amount of natural speech data in a field (target domain) to be subjected to speech recognition, there is a method such as transfer training or fine tuning in which a pre-trained model machine learned using a speech and a text in a domain (field) different from the target domain is first generated, and then the pre-trained model is further machine learned using the speech and the text in the target domain to generate a speech recognition model.

### Citation List

### Patent Literature

PTL 1: JP 2019-120841 A

### SUMMARY OF INVENTION

### Technical Problem

However, in a case where it is difficult to obtain natural speech data of the target domain, it may be difficult to create a speech recognition model having practical recognition accuracy even by a technique such as transfer training or fine tuning.

An aspect of the present invention has been made in view of the above problems, and an object of the present invention is to provide a technique of creating a speech recognition model having practical recognition accuracy even in a case where it is difficult to obtain natural speech data of a target domain.

### Solution to Problem

A speech recognition model training device according to an aspect of the present invention includes a pre-training means for performing machine learning using text data of a target domain and synthesized speech data related to the text data of the target domain and generating a pre-trained model, and an additional training means for further performing machine learning on the pre-trained model using text data of a second domain different from the target domain and natural speech data related to the text data of the second domain and generating a speech recognition model of the target domain.

A speech recognition model training method according to an aspect of the present invention includes a pre-training process of performing machine learning using text data of a target domain and synthesized speech data related to the text data of the target domain and generating a pre-trained model, and an additional training process of further performing machine learning on the pre-trained model using text data of a second domain different from the target domain and natural speech data related to the text data of the second domain and generating a speech recognition model of the target domain.

A speech recognition model training program according to an aspect of the present invention causes a computer to execute a pre-training process of performing machine learning using text data of a target domain and synthesized speech data related to the text data of the target domain and generating a pre-trained model, and an additional training process of further performing machine learning on the pre-trained model using text data of a second domain different from the target domain and natural speech data related to the text data of the second domain and generating a speech recognition model of the target domain.

### Advantageous Effects of Invention

Even in a case where it is difficult to obtain natural speech data of a target domain, a speech recognition model having practical recognition accuracy is created.

### BRIEF DESCRIPTION OF DRAWINGS

FIG. 1 is a block diagram illustrating a configuration of a speech recognition model training device according to a first exemplary embodiment of the present invention.

FIG. 2 is a flowchart illustrating a flow of a speech recognition model training method according to the first exemplary embodiment of the present invention.

FIG. 3 is a block diagram illustrating a configuration of a speech recognition model training device according to a second exemplary embodiment of the present invention.

FIG. 4 is a flowchart illustrating a flow of a speech recognition model training method according to the second exemplary embodiment of the present invention.

FIG. 5 is a block diagram illustrating a configuration of a speech recognition model training device according to a third exemplary embodiment of the present invention.

FIG. 6 is a flowchart illustrating a flow of a speech recognition model training method according to the third exemplary embodiment of the present invention.

FIG. 7 is a block diagram illustrating a hardware configuration example of each device according to each exemplary embodiment of the present invention.

### EXAMPLE EMBODIMENT

### First Exemplary Embodiment

The first exemplary embodiment of the present invention will be described in detail with reference to the drawings. The present exemplary embodiment is a basic form of the exemplary embodiment described below.

### Configuration of Speech Recognition Model Training Device 1

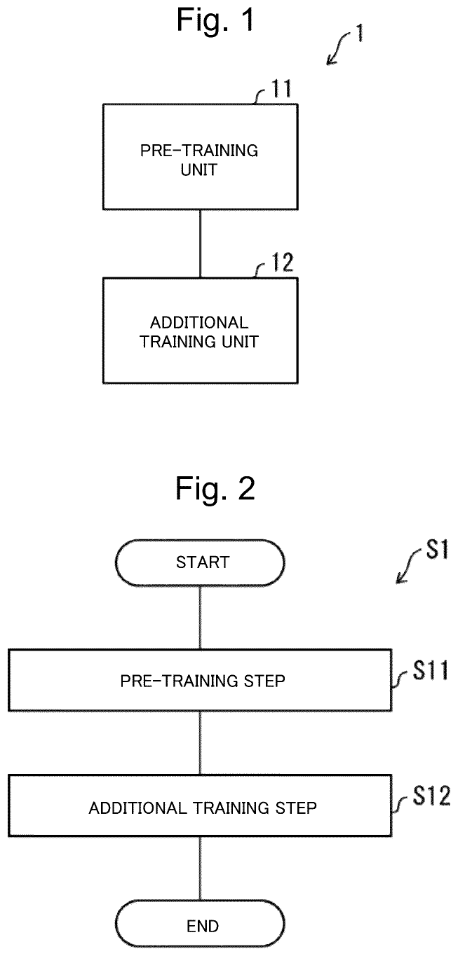

A configuration of a speech recognition model training device 1 according to the present exemplary embodiment will be described with reference to FIG. 1. The speech recognition model is a model used when speech data is automatically converted into text. FIG. 1 is a block diagram illustrating a configuration of a speech recognition model training device 1. As illustrated in FIG. 1, the speech recognition model training device 1 includes a pre-training unit 11 and an additional training unit 12. The pre-training unit 11 performs machine learning using text data of the target domain and synthesized speech data related to the text data to generate a pre-trained model.

The domain refers to a specific field in which information is exchanged by speech or the like. The target domain is a domain to be subjected to speech recognition, and is not particularly limited, and examples thereof include a medical field, a judicial field (including a trial related field and a police related field), and the like.

The text data refers to information exchanged in the form of text. The synthesized speech data refers to speech data artificially synthesized using a computer. The “synthesized speech data related to text data” refers to synthesized speech data obtained by artificially reading text data using a computer.

As a form of the machine learned model used as the pre-trained model, any known model used in speech recognition can be used. Examples thereof include Transformer and BERT.

The additional training unit 12 further performs machine learning on the pre-trained model using text data of a second domain different from the target domain and natural speech data related to the text data, and generates a speech recognition model of the target domain.

The second domain refers to a domain different from the target domain, and may be a domain including part or all of the target domain. The natural speech data is recorded data of a speech uttered by a human, and includes data processed by a computer. As a form of the machine learned model used as the speech recognition model of the target domain, a form similar to the form of the machine learned model used as the pre-trained model can be used.

### Flow of Speech Recognition Model Training Method S1

The speech recognition model training device 1 configured as described above executes a speech recognition model training method S1 according to the present exemplary embodiment. A flow of the speech recognition model training method S1 will be described with reference to FIG. 2. FIG. 2 is a flowchart illustrating a flow of the speech recognition model training method S1. As illustrated in FIG. 2, the speech recognition model training method S1 includes a pre-training step S11 and an additional training step S12. In the pre-training step S11, the pre-training unit 11 performs machine learning using text data of the target domain and synthesized speech data related to the text data of the target domain to generate a pre-trained model. In the additional training step S12, the additional training unit 12 further performs machine learning on the pre-trained model using text data of the second domain and natural speech data related to the text data of the second domain, and generates a speech recognition model of the target domain.

### Effects of Present Exemplary Embodiment

As described above, according to the speech recognition model training device 1 and the speech recognition model training method S1 according to the present exemplary embodiment, it is possible to create a speech recognition model having practical recognition accuracy even in a case where it is difficult to obtain natural speech data of a target domain.

This is because a model related to the topic of the target domain can be generated first using the synthesized speech data of the target domain for machine learning of the pre-trained model. Furthermore, by further performing machine learning on the pre-trained model using the natural speech data in the second domain, it is possible to cope with the speaker variation and suppress the influence of the acoustic feature of the synthesized speech data on the speech recognition model.

### Second Exemplary Embodiment

The second exemplary embodiment of the present invention will be described in detail with reference to the drawings. Components having the same functions as the components described in the first exemplary embodiment are denoted by the same reference numerals, and the description thereof will be omitted as appropriate.

### Configuration of Speech Recognition Model Training Device 10

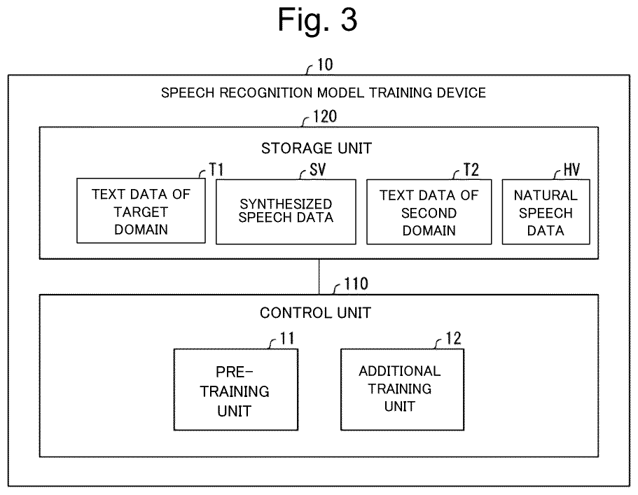

A configuration of a speech recognition model training device 10 according to the second exemplary embodiment of the present invention will be described with reference to FIG. 3. FIG. 3 is a block diagram illustrating a functional configuration of the speech recognition model training device 10. As illustrated in FIG. 3, the speech recognition model training device 10 includes a control unit 110 and a storage unit 120. The control unit 110 integrally controls each unit of the speech recognition model training device 10. The control unit 110 includes the pre-training unit 11 and the additional training unit 12. The storage unit 120 stores various pieces of data used by the control unit 110. For example, the storage unit 120 stores text data T1 of the target domain, synthesized speech data SV, text data T2 of the second domain, and natural speech data HV.

The text data T1 of the target domain is text data of a domain for which a speech recognition model is to be generated. As an example, the target domain is the medical field or the judicial field, and text data of a document (for example, a paper, a judgment document, an article, and the like) related to the medical field or the judicial field may be used as the text data T1.

The synthesized speech data SV is related to the text data T1 of the target domain, and is speech data obtained by performing speech synthesis from the text data by a known means. In an aspect, the speech recognition model training device 10 may include a speech synthesizing means and synthesize the synthesized speech data SV from the text data T1.

The text data T2 of the second domain is text data different from the text data T1 of the target domain. The second domain may be a domain wider than the target domain.

The natural speech data HV is related to the text data T2 of the second domain and is actually recorded speech data.

The pre-training unit 11 performs machine learning using the text data T1 of the target domain and the synthesized speech data SV to generate a pre-trained model.

The additional training unit 12 further performs machine learning on the pre-trained model using the text data T2 of the second domain and the natural speech data HV, and generates a speech recognition model of the target domain.

### Flow of Speech Recognition Model Training Method S10

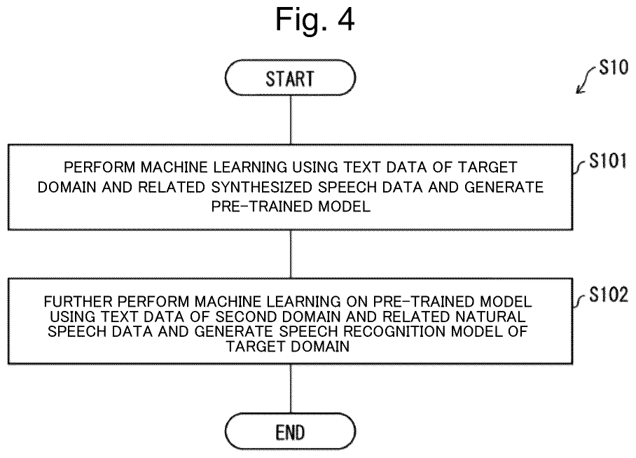

The speech recognition model training device 10 configured as described above executes a speech recognition model training method S10 according to the present exemplary embodiment. A flow of the speech recognition model training method S10 will be described with reference to FIG. 4. FIG. 4 is a flowchart illustrating a flow of the speech recognition model training method S10. As illustrated in FIG. 4, the speech recognition model training method S10 includes steps S101 and S102.

In step S101, the pre-training unit 11 performs machine learning using the text data T1 of the target domain and the related synthesized speech data SV to generate a pre-trained model.

In step S102, the additional training unit 12 further performs machine learning on the pre-trained model using the text data T2 of the second domain and the related natural speech data HV, and generates a speech recognition model of the target domain.

### Effects of Present Exemplary Embodiment

Also in the present exemplary embodiment, as in the first exemplary embodiment, even in a case where it is difficult to obtain natural speech data of a target domain, a speech recognition model having practical recognition accuracy can be created. Specifically, it is effective for creating a speech recognition model in which a medical field or a judicial field (including judge related field, police related field) in which there is little disclosed natural speech data is set as a target domain.

### Third Exemplary Embodiment

A third exemplary embodiment of the present invention will be described in detail with reference to the drawings. Components having the same functions as the components described in the first exemplary embodiment are denoted by the same reference numerals, and the description thereof will be omitted as appropriate.

### Configuration of Speech Recognition Model Training Device 20

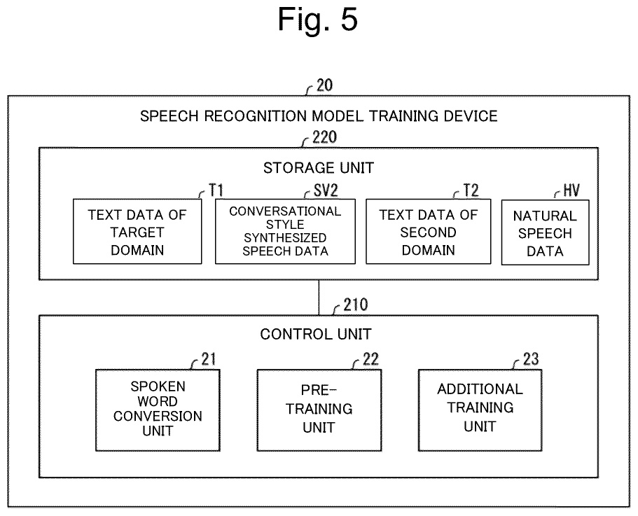

A configuration of a speech recognition model training device 20 according to the third exemplary embodiment of the present invention will be described with reference to FIG. 5. FIG. 5 is a block diagram illustrating a functional configuration of the speech recognition model training device 20. As illustrated in FIG. 5, the speech recognition model training device 20 includes a control unit 210 and a storage unit 220. The control unit 210 integrally controls each unit of the speech recognition model training device 20. The control unit 210 includes a spoken word conversion unit 21, a pre-training unit 22, and an additional training unit 23. The storage unit 220 stores various pieces of data used by the control unit 210. For example, the storage unit 220 stores text data T1 of the target domain, conversational style synthesized speech data SV2, text data T2 of the second domain, and natural speech data HV.

The spoken word conversion unit 21 converts the text data Tl of the target domain into a conversational style. The method of converting the text data into the conversational style is not particularly limited, but for example, a correspondence table of written words and spoken words may be prepared in advance, and the spoken word conversion unit 21 may convert the text data into the conversational style with reference to the correspondence table.

The pre-training unit 22 performs machine learning using the text data, of the target domain, converted into the conversational style and the conversational style synthesized speech data SV2 to generate a pre-trained model. The conversational style synthesized speech data SV2 is synthesized speech data related to the text data, of the target domain, converted into the conversational style.

The additional training unit 23 further performs machine learning on the pre-trained model using the text data T2 of the second domain and the natural speech data HV, and generates a speech recognition model of the target domain.

Flow of speech Recognition Model Training Method S20

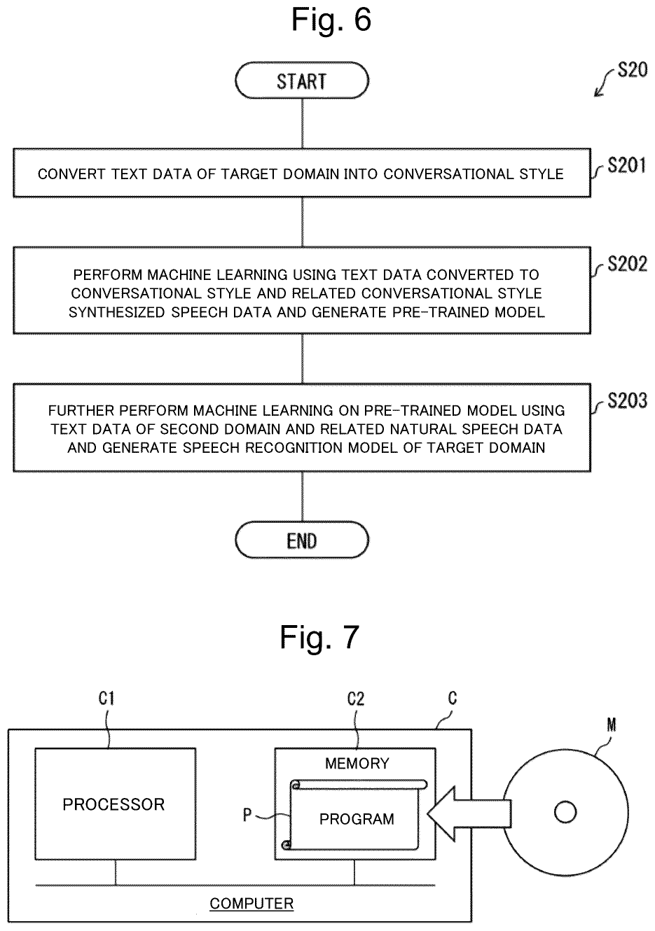

The speech recognition model training device 20 configured as described above executes a speech recognition model training method S20 according to the present exemplary embodiment. A flow of the speech recognition model training method S20 will be described with reference to FIG. 6. FIG. 6 is a flowchart illustrating a flow of the speech recognition model training method S20. As illustrated in FIG. 6, the speech recognition model training method S20 includes steps S201 to S203.

In step S201, the spoken word conversion unit 21 converts the text data T1 of the target domain into a conversational style.

In step S202, the pre-training unit 22 performs machine learning using the text data converted into the conversational style and the related conversational style synthesized speech data SV2 to generate a pre-trained model.

In step S203, the additional training unit 23 further performs machine learning on the pre-trained model using the text data T2 of the second domain and the related natural speech data HV, and generates a speech recognition model of the target domain.

### Effects of Present Exemplary Embodiment

In the present exemplary embodiment, the pre-trained model is generated using the text data T1 of the target domain converted into conversational style. As a result, even in a case where the text data of the target domain is a document (for example, a paper, a judgment document, an article, and the like), it is possible to train a word string related to the way of speaking, and it is possible to create a speech recognition model having higher recognition accuracy.

### Implementation Example by Software

Some or all of the functions of the speech recognition model training devices 1, 10, and 20 (hereinafter, each device will be described) may be achieved by hardware such as an integrated circuit (IC chip) or may be achieved by software.

In the latter case, each device is achieved by, for example, a computer that executes an instruction of a program that is software for achieving each function. An example of such a computer (hereinafter, referred to as a computer C) is illustrated in FIG. 7. The computer C includes at least one processor C1 and at least one memory C2. A program P for operating the computer C as each device is recorded in the memory C2. In the computer C, the processor C1 reads the program P from the memory C2 and executes the program P to implement each function of each device.

As the processor C1, for example, a central processing unit (CPU), a graphic processing unit (GPU), a digital signal processor (DSP), a micro processing unit (MPU), a floating point number processing unit (FPU), a physics processing unit (PPU), a tensor processing unit (TPU), a quantum processor, a microcontroller, or a combination thereof may be used. As the memory C2, for example, a flash memory, a hard disk drive (HDD), a solid state drive (SSD), or a combination thereof can be used.

The computer C may further include a random access memory (RAM) for developing the program P at the time of execution and temporarily storing various pieces of data. The computer C may further include a communication interface for transmitting and receiving data to and from another device. The computer C may further include an input/output interface that connects input/output devices such as a keyboard, a mouse, a display, and a printer.

The program P can be recorded on a non-transitory tangible recording medium M readable by the computer C. As such a recording medium M, for example, a tape, a disk, a card, a semiconductor memory, a programmable logic circuit, or the like can be used. The computer C can acquire the program P via such a recording medium M. The program P can be transmitted via a transmission medium. As such a transmission medium, for example, a communication network, a broadcast wave, or the like can be used. The computer C can also acquire the program P via such a transmission medium.

### Supplementary Note Item 1

The present invention is not limited to the above-described example embodiments, and various modifications can be made within the scope indicated in the claims. For example, example embodiments obtained by appropriately combining the technical means disclosed in the above-described example embodiments are also included in the technical scope of the present invention.

### Supplementary Note Item 2

Some or all of the above-described example embodiments may also be described as follows. However, the present invention is not limited to the following aspects.

### Supplementary Note 1

A speech recognition model training device including a pre-training means for performing machine learning using text data of a target domain and synthesized speech data related to the text data of the target domain and generating a pre-trained model, and an additional training means for further performing machine learning on the pre-trained model using text data of a second domain different from the target domain and natural speech data related to the text data of the second domain and generating a speech recognition model of the target domain.

### Supplementary Note 2

The speech recognition model training device according to Supplementary Note 1, further including
a spoken word conversion means for converting text data of the target domain into a conversational style, wherein
the pre-training means performs machine learning using text data, of the target domain, converted into a conversational style and synthesized speech data related to the text data, of the target domain, converted into the conversational style.

### Supplementary Note 3

The speech recognition model training device according to Supplementary Note 1 or 2, wherein
the target domain is a medical field, and
text data of the target domain includes text data of a document related to the medical field.

### Supplementary Note 4

A speech recognition model training method including
a pre-training process of performing machine learning using text data of a target domain and synthesized speech data related to the text data of the target domain and generating a pre-trained model, and
an additional training process of further performing machine learning on the pre-trained model using text data of a second domain different from the target domain and natural speech data related to the text data of the second domain and generating a speech recognition model of the target domain.

### Supplementary Note 5

The speech recognition model training method according to Supplementary Note 4, further including
executing a spoken word conversion process of converting text data of the target domain into a conversational style, wherein
the pre-training process includes performing machine learning using text data, of the target domain, converted into a conversational style and synthesized speech data related to the text data, of the target domain, converted into the conversational style.

### Supplementary Note 6

The speech recognition model training method according to Supplementary Note 4 or 5, wherein
the target domain is a medical field, and
text data of the target domain includes text data of a document related to the medical field.

### Supplementary Note 7

A speech recognition model training program for causing a computer to execute
a pre-training process of performing machine learning using text data of a target domain and synthesized speech data related to the text data of the target domain and generating a pre-trained model, and
an additional training process of further performing machine learning on the pre-trained model using text data of a second domain different from the target domain and natural speech data related to the text data of the second domain and generating a speech recognition model of the target domain.

### Supplementary Note 8

The speech recognition model training program according to Supplementary Note 7, for causing the computer to further execute
a spoken word conversion process of converting text data of the target domain into a conversational style, wherein
the pre-training process includes performing machine learning using text data, of the target domain, converted into a conversational style and synthesized speech data related to the text data, of the target domain, converted into the conversational style.

### Supplementary Note 9

The speech recognition model training program according to Supplementary Note 7 or 8, wherein
the target domain is a medical field, and
text data of the target domain includes text data of a document related to the medical field.

### Supplementary Note 10

A speech recognition model training device including
at least one processor,
the processor executing
a pre-training process of performing machine learning using text data of a target domain and synthesized speech data related to the text data of the target domain and generating a pre-trained model, and
an additional training process of further performing machine learning on the pre-trained model using text data of a second domain different from the target domain and natural speech data related to the text data of the second domain and generating a speech recognition model of the target domain.

The speech recognition model training device may further include a memory, and the memory may store a program for causing the processor to execute the pre-training process and the additional training process. This program may be recorded in a computer-readable non-transitory tangible recording medium.

### Reference Signs List

1, 10,20 speech recognition model training device
11 pre-training unit
12 additional training unit
21 spoken word conversion unit
22 pre-training unit
23 additional training unit
110, 210 control unit 120, 220 storage unit
C1 processor
C2 memory

What is claimed is:

1. A speech recognition model training device comprising:
a memory configured to store instructions; and
one or more processors configured to execute the instructions to:
perform machine learning using text data of a target domain and synthesized speech data related to the text data of the target domain and generate a pre-trained model; and
perform machine learning on the pre-trained model using text data of a second domain different from the target domain and natural speech data related to the text data of the second domain and generate a speech recognition model of the target domain.

2. The speech recognition model training device according to claim 1, wherein
the one or more processors are further configured to execute the instructions to:
convert text data of the target domain into a conversational style; and
perform machine learning using text data, of the target domain, converted into a conversational style and synthesized speech data related to the text data, of the target domain, converted into the conversational style.

3. The speech recognition model training device according to claim 1, wherein
the target domain is a medical field or a judicial field, and
text data of the target domain includes text data of a document related to the medical field or the judicial field.

4. A speech recognition model training method comprising:
performing machine learning using text data of a target domain and synthesized speech data related to the text data of the target domain and generating a pre-trained model; and
performing machine learning on the pre-trained model using text data of a second domain different from the target domain and natural speech data related to the text data of the second domain and generating a speech recognition model of the target domain.

5. The speech recognition model training method according to claim 4, further comprising:
converting text data of the target domain into a conversational style; and
performing machine learning using text data, of the target domain, converted into a conversational style and synthesized speech data related to the text data, of the target domain, converted into the conversational style.

6. The speech recognition model training method according to claim 4, wherein
the target domain is a medical field or a judicial field, and
text data of the target domain includes text data of a document related to the medical field or the judicial field.

7. A non-transitory computer-readable recording medium stored with a speech recognition model training program for causing a computer to execute:
a pre-training process of performing machine learning using text data of a target domain and synthesized speech data related to the text data of the target domain and generating a pre-trained model; and
an additional training process of further performing machine learning on the pre-trained model using text data of a second domain different from the target domain and natural speech data related to the text data of the second domain and generating a speech recognition model of the target domain.

8. The non-transitory computer-readable recording medium stored with the speech recognition model training program according to claim 7, for causing the computer to further execute:
a spoken word conversion process of converting text data of the target domain into a conversational style, wherein
the pre-training process includes performing machine learning using text data, of the target domain, converted into a conversational style and synthesized speech data related to the text data, of the target domain, converted into the conversational style.

9. The non-transitory computer-readable recording medium stored with the speech recognition model training program according to claim 7, wherein
the target domain is a medical field or a judicial field, and
text data of the target domain includes text data of a document related to the medical field or the judicial field.
